(19) United States
(12) Patent Application Publication
(10) Pub. No.: US 2026/0357826 A1
(43) Pub. Date: Nov. 12, 2026

(54) PRESSURE-COMPENSATED HYDRAULIC VALVE AND HYDRAULIC SYSTEM

(71) Applicant: HAWE Hydraulik SE, Aschheim (DE)

(72) Inventors: Georg Jemüller, Aschheim (DE); Thomas Ott, Aschheim (DE); Yasin Abdullahi, Aschheim (DE); Clement Eberhardt, München (DE)

(73) Assignee: HAWE Hydraulik SE, Aschheim (DE)

(21) Appl. No.: 19/669,395

(22) Filed: May 6, 2026

(30) Foreign Application Priority Data
May 7, 2025 (DE) 10 2025 117 54.1

(51) Int. Cl. F15B 13/02; F15B 13/04; F15B 13/044

(52) U.S. Cl. CPC F15B 13/026; F15B 13/0402; F15B 13/0407; F15B 13/044

(57) ABSTRACT

A pressure-compensated hydraulic valve comprising a first connection, a second connection, a housing with a piston bore, a valve piston movably disposed in the piston bore with a first pressure surface and a second pressure surface, a compensation device, and a damping device disposed between the first connection and the compensation device. The valve piston may be movable relative to the housing between a first position and a second position. A pressure acting on the first pressure surface can be applied to the second pressure surface via the compensation device for pressure compensation. The disclosure also relates to a hydraulic system including the pressure-compensated hydraulic valve.

### CROSS-REFERENCE TO RELATED APPLICATION

This application claims priority from German Application No. DE 10 2025 117 541.1 filed May 7, 2025, the entire contents of which is incorporated herein by reference.

### FIELD

The present disclosure relates to a pressure-compensated hydraulic valve, and to a hydraulic system with such a pressure-compensated hydraulic valve.

### BACKGROUND

Pressure-compensated hydraulic valves generally have at least a first connection, a second connection, a housing with a piston bore, a valve piston movably disposed in the piston bore with a first pressure surface and a second pressure surface, and a compensation device. Such pressure-compensated hydraulic valves are regularly used to block connections to each other without oil leakage or to release the connection between the connections by the valve piston being movable relative to the housing between a first position and a second position. Depending on the configuration of the valve, the valve piston may be biased into the first position or the second position.

### SUMMARY

The present disclosure therefore aims to provide an improved pressure-compensated hydraulic valve which does not open unintentionally and can be manufactured cost effectively. This problem is solved with a pressure-compensated hydraulic valve disclosed herein and a hydraulic system also disclosed herein. Preferable further embodiments are also described herein.

The pressure-compensated hydraulic valve according to the disclosure includes a damping device disposed between the first connection and the compensation device. The damping device is configured to dampen the pressure acting on the first connection and on the first pressure surface with regard to the vibrations. This smooths out the pulsating pressure and significantly reduces the force acting on the valve piston. This effectively prevents the hydraulic valve from opening unintentionally.

In other words, the damping device is disposed between the pressure surfaces and the compensation device located between them, which does not impede the volume compensation between the first pressure surface and the second pressure surface required when switching the hydraulic valve, but dampens any vibration (or pulsating pressure) present in the first connection in front of the pressure surfaces. The first pressure surface and the second pressure surface may be approximately the same size.

The compensation device may have a compensation bore through the valve piston connecting the first pressure surface to the second pressure surface. Such a compensation bore is space-saving and easy to manufacture.

The first position may be a closed position and the second position may be an open position. The hydraulic valve may have a preload element, wherein the preload element preloads the valve piston into the closed position or the open position. The first connection and the second connection may be blocked in the closed position of the valve piston. The first connection and the second connection may be connected to each other in the open position of the valve piston. This may result in a particularly simple pressure-compensated hydraulic valve.

The valve piston may have a valve cone. The housing therefore may also have a valve seat, whereby the valve cone rests on the valve seat in the closed position and is lifted off the valve seat in the open position. This enables leak-free shut-off of the connection between the first connection and the second connection in the closed position.

A configuration as a spool valve or as a 3/2-way valve is also possible.

The damping device may have a throttle point. The throttle point may dampen the pulsating pressure transmitted to the two pressure surfaces and then applied there.

The throttle point may be formed by a gap between the housing and the valve piston. For this purpose, the valve piston may have a circular cylindrical spool section, with the housing having a guide section. The spool section may extend axially from the first pressure surface and may be guided in the guide section so that the gap is formed between the spool section and the guide section. This enables the throttle point to be provided in a cost-effective manner. Furthermore, the resulting throttling resistance can be adapted to the hydraulic application by suitably selecting the diameters of the spool section and the guide section and the length of the gap.

The damping device may have a compression volume. The compression volume dampens the pulsating pressure applied to the first connection.

The compression volume may extend at least partially between an axial end of the piston bore and the first pressure surface. This allows the compression volume to be manufactured particularly easily as part of the piston bore that has to be manufactured anyway.

The compression volume may be connected to a third connection. The third connection can, for example, be blindly closed or connected to a blind volume. It is also conceivable that a pressure accumulator may be connected via the third connection. The compression volume can thus be formed at least in part by the pressure accumulator. This has the advantage that the damping of the pulsating pressure can be adjusted, for example by providing or not providing a pressure accumulator.

The throttle point may be located downstream of the first connection in the direction of flow seen from the first connection and upstream of the compression volume. This results in a series connection in which the hydraulic fluid first flows from the first connection through the throttle point and then into the compression volume. This results in sufficient damping, particularly in the closed position, of the pressure enclosed but pulsating in the closed position, so that any force on the valve piston that may result from this under unfavorable circumstances cannot cause the valve to open unintentionally.

The hydraulic valve has a spring chamber, with the preload element disposed in the spring chamber, and with the spring chamber preferably formed in the area of the second pressure surface. This results in a particularly easy-to-install and compact valve.

The hydraulic valve may have an electromagnet for moving the valve piston against a force of the preload element, with the electromagnet preferably being disposed on the side of the second pressure surface. This enables a particularly compact valve design.

The pressure-compensated hydraulic valve may be at least partially configured as a valve cartridge. This facilitates assembly.

The present disclosure also relates to a hydraulic system with at least one hydraulic pump and at least one hydraulic consumer. According to the disclosure, the hydraulic system has at least one pressure-compensated hydraulic valve as described herein.

### BRIEF DESCRIPTION OF THE DRAWINGS

The present disclosure is explained in more detail below with reference to an exemplary embodiment shown in the figures, wherein:

FIG. 1 shows a simplified hydraulic circuit diagram of a hydraulic system with a pressure-compensated hydraulic valve, according to one or more embodiments shown and described herein;

FIG. 2 shows a cross-section through a pressure-compensated hydraulic valve with a valve piston in the closed position, according to one or more embodiments shown and described herein;

FIG. 3 shows the hydraulic valve shown in FIG. 2, wherein the valve piston is moved into the open position, according to one or more embodiments shown and described herein; and

FIG. 4 shows an enlarged view of the circled portion of the hydraulic valve shown in FIG. 2, according to one or more embodiments shown and described herein.

### DETAILED DESCRIPTION

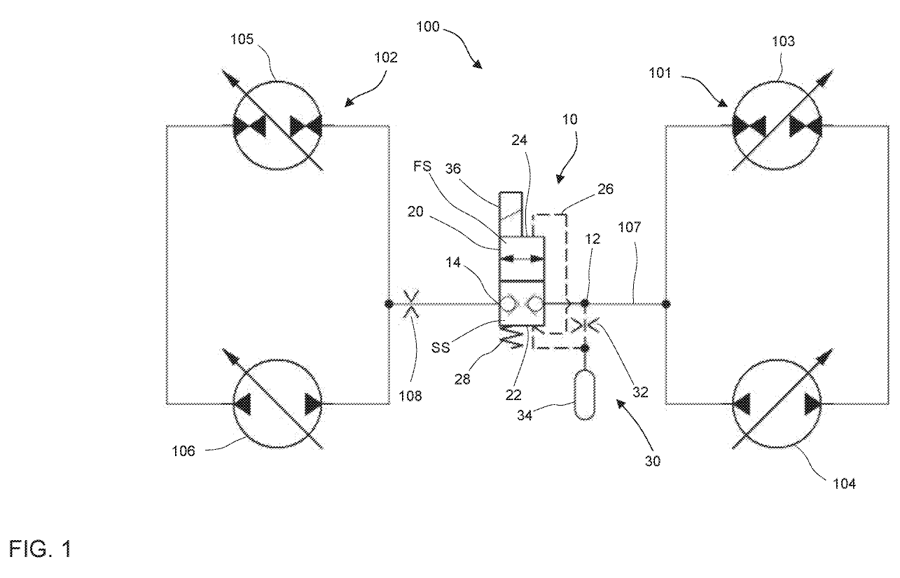

FIG. 1 shows a simplified hydraulic circuit diagram of a hydraulic system 100 with a pressure-compensated hydraulic valve 10 according to the disclosure. In this embodiment, the hydraulic system 100 is configured as a winch system for a cable excavator and comprises a first hydraulic circuit 101 and a second hydraulic circuit 102. The first hydraulic circuit 101 comprises a first reversible and controllable hydraulic pump 103 and a first hydraulic consumer 104, namely a first hydraulically driven winch. The second hydraulic circuit 102 comprises a second reversible and controllable hydraulic pump 105 and a second hydraulic consumer 106, which is also configured as a hydraulically driven winch. The first winch 104 is configured in a known manner to raise and lower an excavator bucket, and the second winch 106 is configured in a known manner to open and close the bucket. In order to implement the desired function, the first hydraulic pump 103 and the second hydraulic pump 105 are operated in a known manner in one or the other direction of flow.

Pressure-compensated hydraulic valves may be used to block connections to each other without oil leakage or to release the connection between the connections by the valve piston being movable relative to the housing between a first position and a second position. Depending on the configuration of the valve, the valve piston may be biased into the first position or the second position. Due to the pressure compensation via the compensation device, the pressure at the first connection to be blocked has no influence on the necessary switching forces. For this purpose, the pressure applied to the first pressure surface is transmitted to the second pressure surface via the compensation device. In other words, a pressure applied to the first pressure surface can be applied to the second pressure surface via the compensation device. The first pressure surface and the second pressure surface may be largely identical in terms of area, so that the resulting forces cancel each other out. The compensation device can, for example, be configured as a compensation bore that completely penetrates the valve piston.

Such pressure-compensated valves are used in a wide variety of hydraulic systems, for example in cable excavators. In cable excavators, two hydraulically operated cable winches are used, each in its own closed hydraulic circuit. One cable winch is used to raise or lower a bucket, while the other cable winch is used to open or close the bucket. Each hydraulic circuit therefore has a control pump with a changing delivery direction. Depending on whether the cable winch raises or lowers the bucket or closes or opens the bucket, the respective control pump is operated in one or the other delivery direction. The two hydraulic circuits are connected for compensation via a pressure-compensated hydraulic valve, which is normally biased to a lock position.

If the bucket is now raised or lowered with the valve closed (i.e., the valve piston is in a closed position), pressure oscillations act on the valve piston. These pressure oscillations are inevitable and always occur due to the control pumps, which, due to their design, cannot generate a homogeneous flow. Rather, the pulsating pressure applied is influenced by the number of pump elements, the speed, the pressure, and other design features of the pump and the hydraulic circuit. This can lead to high vibration amplitudes and frequencies, which act on the first pressure surface in conventional valves. This pulsating pressure acting on the first pressure surface is not transmitted directly to the second pressure surface via the compensation device, but with a certain time delay due to the dimensions of the compensation device (e.g., the length of the compensation bore) and the speed of sound in the hydraulic fluid. This time delay in the pressure signal and the pulsating pressure result in a force acting on the valve piston which, under unfavorable and normally unexpected conditions, unintentionally pushes the valve piston hydraulically out of the closed position. Unintentional opening of the pressure-compensated hydraulic valve is of course undesirable and must be prevented.

To prevent unwanted opening, a larger or shorter compensation bore can be provided, for example. However, the dimension of the compensation bore is limited by the design and size of the valve piston. It is therefore generally not possible to enlarge or shorten the compensation bore. It is also conceivable to provide the compensation bore in the housing or in a block accommodating the valve and thus make it larger or shorter. This increases the manufacturing effort and thus also the costs. The problem can also be countered by pressure relief on both sides of the valve piston, i.e., on the side of the first pressure surface and on the side of the second pressure surface. This also increases the manufacturing effort and thus the costs.

The first hydraulic circuit 101 and the second hydraulic circuit 102 are connected to each other via a connecting line 107. The pressure-compensated hydraulic valve 10 is disposed in the connecting line 107. A hydraulic resistor 108 is disposed in the connecting line 107 between the hydraulic valve 10 and the second hydraulic circuit 102.

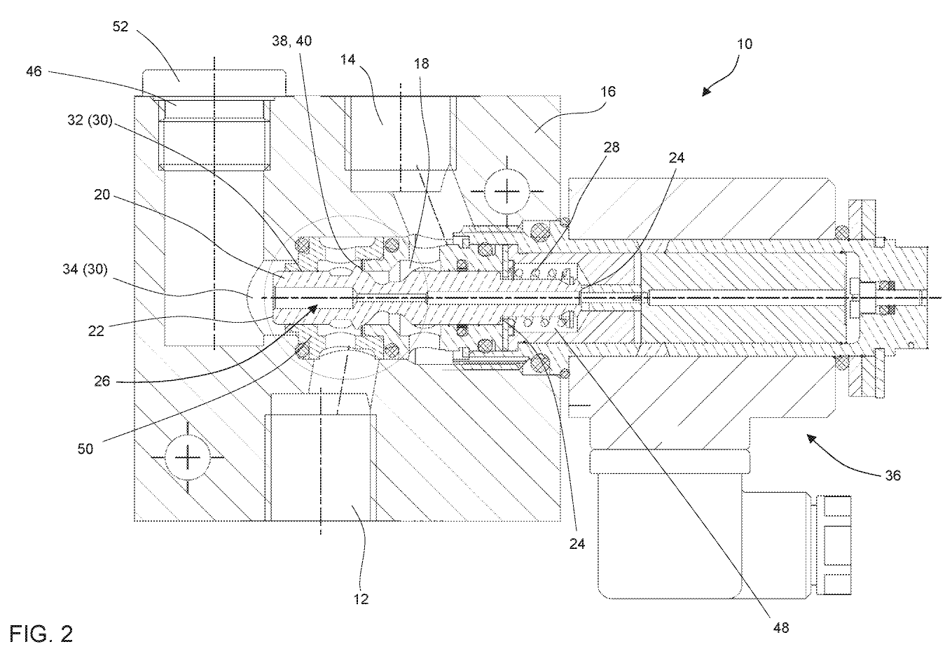

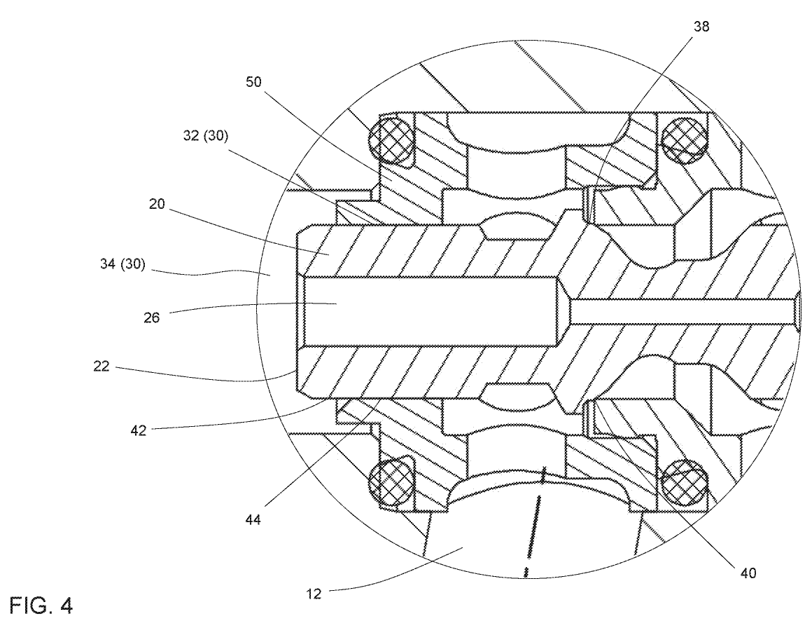

As shown in FIGS. 1-4, the hydraulic valve 10 is configured as a 2/2-way valve and has a first connection 12 and a second connection 14. As shown, the first hydraulic circuit 101 is connected to the first connection 12 via the connecting line 107, and the second hydraulic circuit 102 is connected to the second connection 14 via the connecting line 107. The hydraulic valve 10 also has a housing 16 with a piston bore 18, see FIGS. 2 and 4. FIG. 4 shows the detail of FIG. 2 marked with a dashed circle.

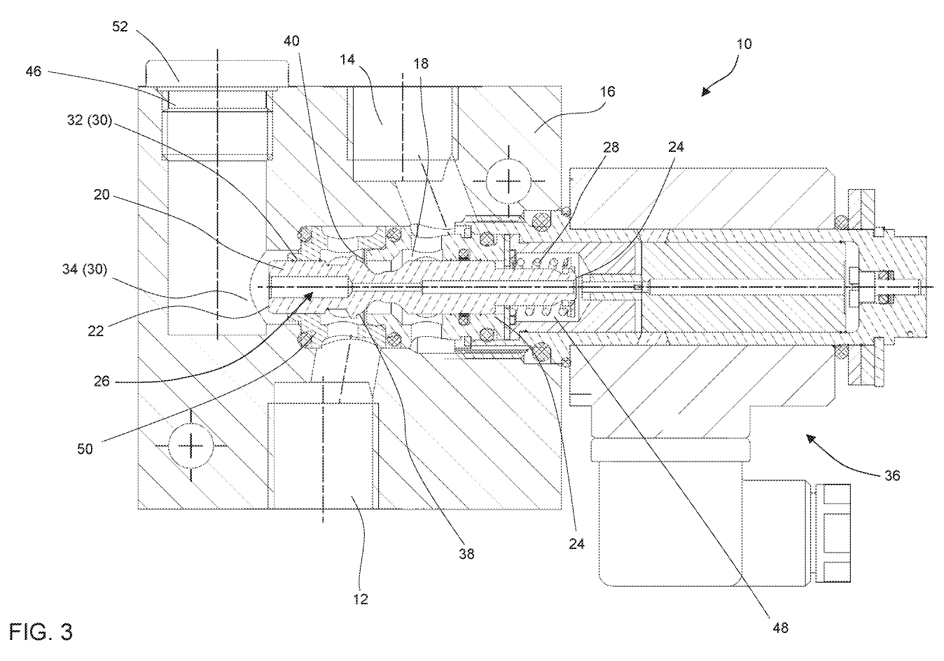

An axially movable valve piston 20 is disposed in the piston bore 18. The valve piston 20 comprises a valve cone 38 and can be switched between a closed position SS and an open position FS. In the closed position SS of the valve piston 20 shown in FIGS. 1 and 2, a connection between the first connection 12 and the second connection 14 is closed without oil leakage, as the valve cone 38 rests against a valve seat 40 provided at the housing 16. In the open position FS of the valve piston 20 shown in FIG. 3, the valve cone 38 is lifted off the valve seat 40 and the connection from the first connection 12 to the second connection 14 is open, so that pressure compensation can take place between the first hydraulic circuit 101 and the second hydraulic circuit 102. Of course, a design as a spool valve or as a 3/2-way valve, for example, is also possible.

The valve piston 20 has a first pressure surface 22 and a second pressure surface 24. As shown in FIG. 2, the first pressure surface 22 and the second pressure surface 24 are each formed by the end faces or surfaces of the valve piston 20. In this embodiment, the second pressure surface 24 is formed in a known manner by several annular surfaces, as indicated by the repeated use of the reference numeral 24. The first pressure surface 22 and the second pressure surface 24 are approximately the same size. For optimized movement of the valve piston 20, the hydraulic valve 10 is pressure-compensated in a known manner. For this purpose, the hydraulic valve 10 has a compensation device 26 which transmits the pressure acting on the first pressure surface 22 to the second pressure surface 24, so that, ideally, an identical hydraulic pressure acts on both pressure surfaces 22, 24. As shown in FIG. 2, the compensation device in this embodiment is configured as a compensation bore 26 through the valve piston 20.

The hydraulic valve 10 also has a preload element 28 which preloads the valve piston 20 into the closed position SS. As shown in FIG. 2, the preload element 28 in this embodiment is configured as a coil spring which is disposed in a spring chamber 48 of the hydraulic valve 10. The spring chamber 48 is formed in the area of the second pressure surface 24. Depending on the application, it is of course also conceivable that the preload element 28 preloads the valve piston into the open position FS.

To switch the valve piston 20, the hydraulic valve 10 has an electromagnet 36 which, when energized, switches the valve piston 20 from the closed position SS to the open position FS against the closing force of the preload element 28. Consequently, the hydraulic valve 10 is closed when de-energized. As shown in FIGS. 2 and 3, the electromagnet 36 is disposed on the side of the second pressure surface 24.

Due to the compensation bore 26, there is a certain time delay between the pressure applied to the first pressure surface 22 being transmitted to the second pressure surface 24, which, assuming a constant speed of sound in the hydraulic fluid and assuming constant compressibility of the hydraulic fluid, depends in particular on the length and diameter of the compensation bore 26.

Since the first hydraulic pump 103 does not build up homogeneous pressure due to its design, but rather a pulsating pressure that depends on the number of pump elements used and the speed of the first hydraulic pump 103, this pulsating pressure is also present at the first connection 12. If this pulsating pressure were to act directly on the first pressure surface 22, the time delay in the signal to the second pressure surface 24 via the compensation bore 26 would result in a force acting on the valve piston. Under particularly unfavorable conditions, which are not normally to be expected, this force may be sufficient to push the valve piston against the preload force of the preload element 28, i.e., to switch it unintentionally to the open position.

To prevent such unwanted switching, the hydraulic valve 10 has a damping device 30. The damping device 30 comprises a throttle point 32 and a compression volume 34. As shown in FIG. 1, the throttle point 32 and the compression volume 34 are connected in series between the first connection 12 and the first pressure surface 22. Viewed in the direction of flow from the first connection 12, the throttle point 32 is disposed downstream of the first connection 12 and the compression volume 34 is disposed downstream of the throttle point 32 and upstream of the first pressure surface 22 or the compensation bore 26. The pulsating pressure applied to the first connection 12 is therefore not applied directly to the first pressure surface 22, but is first damped by the damping device 30. Although, due to the design of the compensation bore 26, there is still a time lag or period shift in the applied pressure between the first pressure surface 22 and the second pressure surface 24, at least the oscillation amplitude of the pressure is damped to such an extent that the resulting force on the valve piston 20 is significantly reduced. This significantly reduced force acting on the valve piston 20 against the preload force of the preload element 28 is not sufficient to unintentionally push the valve piston 20 from the closed position SS to the open position FS.

For this purpose, the throttle point 32 is configured as a gap between a circular cylindrical spool section 42 of the valve piston 20 and a guide section 44 of the valve housing 16, see FIG. 4. The spool section 42 is guided in the guide section 44. The guide section 44 of the valve housing 16 is disposed on a sleeve 50 received in the piston bore 18. Of course, the sleeve 50 can also be omitted and the guide section 44 can be formed directly on a surface of the piston bore 18. As can be seen from FIG. 4, the spool section 42 extends axially from the second pressure surface 24 in the direction of the valve cone 38.

In order to form the compression volume 34, the housing 16 in the embodiment shown in FIGS. 2-4 has a third connection 46 which is closed by a plug 52. The compression volume 34 is thus formed by the chamber created on the side of the second pressure surface 24 and extends partially between an axial end of the piston bore 18 and the first pressure surface 22. Depending on requirements, the expansion of the compression volume 34 can thus be adjusted, for example by using a (small) pressure accumulator fixed to the third connection 46 instead of the plug 52.

Due to the arrangement described above, when the valve piston 20 is moved from the closed position SS (see FIG. 2) to the open position FS (see FIG. 3) by energizing the electromagnet 36, the pressure applied to the first connection 12 is not immediately transmitted to the first pressure surface 22. Instead, the hydraulic fluid must first flow through the throttle point 32 formed as gap into the compression volume 34. The damping device 30 is therefore designed to dampen the pressure applied to the first connection 12 and acting on the first pressure surface 22 in relation to the pulsation of the hydraulic pump 3 caused by its design. The pressure transmitted to the second pressure surface 24 with a time delay via the compensation bore 26 is thus also damped. The total force acting on the valve piston 20 due to the time delay in the transmission between the first pressure surface 22 and the second pressure surface 24 and the pressure pulsation is thus no longer sufficient to hydraulically deflect the valve piston 20 out of the locking position against the closing force of the preload element 28.

1. A pressure-compensated hydraulic valve, comprising:
a first connection,
a second connection,
a housing with a piston bore,
a valve piston movably disposed in the piston bore with a first pressure surface and a second pressure surface, wherein the valve piston is movable relative to the housing between a first position and a second position,
a compensation device, and
a damping device disposed between the first connection and the compensation device,
wherein a pressure acting on the first pressure surface is applied to the second pressure surface via the compensation device for pressure compensation.

2. The pressure-compensated hydraulic valve of claim 1, wherein the compensation device comprises a compensation bore through the valve piston connecting the first pressure surface to the second pressure surface.

3. The pressure-compensated hydraulic valve of claim 1, wherein:
the first position is a closed position and the second position is an open position,
the hydraulic valve has a preload element, wherein the preload element preloads the valve piston into the closed position or the open position,
the first connection and the second connection are blocked in the closed position of the valve piston, and
the first connection and the second connection are connected to each other in the open position of the valve piston.

4. The pressure-compensated hydraulic valve of claim 3, wherein the valve piston has a valve cone and the housing has a valve seat, wherein the valve cone rests against the valve seat in the closed position and is lifted off the valve seat in the open position.

5. The pressure-compensated hydraulic valve of claim 1, wherein the damping device has a throttle point.

6. The pressure-compensated hydraulic valve of claim 5, wherein the throttle point is formed by a gap between the housing and the valve piston.

7. The pressure-compensated hydraulic valve of claim 6, wherein the valve piston has a spool section extending axially from the first pressure surface and the housing has a guide section, wherein the spool section is guided in the guide section and the gap is formed between the spool section and the guide section.

8. The pressure-compensated hydraulic valve of claim 7, wherein the spool section comprises a circularly cylindrical spool section.

9. The pressure-compensated hydraulic valve of claim 5, wherein the damping device has a compression volume, and the throttle point is disposed downstream of the first connection when viewed in a direction of flow from the first connection and upstream of the compression volume.

10. The pressure-compensated hydraulic valve of claim 1, wherein the damping device has a compression volume.

11. The pressure-compensated hydraulic valve of claim 10, wherein the compression volume extends at least partially between an axial end of the piston bore and the first pressure surface.

12. The pressure-compensated hydraulic valve of claim 10, wherein the compression volume is connected to a third connection.

13. The pressure-compensated hydraulic valve of claim 10, wherein the compression volume is at least partially formed by a pressure accumulator.

14. The pressure-compensated hydraulic valve of claim 3, wherein the hydraulic valve has a spring chamber, wherein the preload element is disposed in the spring chamber.

15. The pressure-compensated hydraulic valve of claim 14, wherein the spring chamber is formed in an area of the second pressure surface.

16. The pressure-compensated hydraulic valve of claim 3, wherein the hydraulic valve has an electromagnet for moving the valve piston against a force of the preload element.

17. The pressure-compensated hydraulic valve of claim 16, wherein the electromagnet is disposed on a side of the second pressure surface.

18. A hydraulic system, comprising:
a hydraulic pump,
a hydraulic consumer, and
the pressure-compensated hydraulic valve of claim 1.
